(19) United States
(12) Patent Application Publication
(10) Pub. No.: US 2025/0368571 A1
(43) Pub. Date: Dec. 4, 2025

(54) METHOD FOR RECYCLING CONCRETE CONSTRUCTION AND/OR DEMOLITION WASTE

(71) Applicants: INSTITUT NATIONAL POLYTECHNIQUE DE TOULOUSE, Toulouse Cedex 4 (FR); UNIVERSITE TOULOUSE III - PAUL SABATIER, Toulouse Cedex 9 (FR); INSA ROUEN NORMANDIE, Saint-Etienne-du-Rouvray (FR); CENTRE NATIONAL DE LA RECHERCHE SCIENTIFIQUE, Paris (FR); UNIVERSITE DE ROUEN NORMANDIE, Mont Saint Aignan Cedex (FR)

(72) Inventors: Florent BOURGEOIS, Toulouse Cedex 4 (FR); Martin CYR, Toulouse Cedex 4 (FR); Lionel ESTEL, Saint-Étienne-du-Rouvray (FR); Célia GURDJOS, Toulouse (FR)

(73) Assignees: INSTITUT NATIONAL POLYTECHNIQUE DE TOULOUSE, Toulouse Cedex 4 (FR); UNIVERSITE TOULOUSE III - PAUL SABATIER, Toulouse Cedex 9 (FR); INSA ROUEN NORMANDIE, Saint-Etienne-du-Rouvray (FR); CENTRE NATIONAL DE LA RECHERCHE SCIENTIFIQUE, Paris (FR); UNIVERSITE DE ROUEN NORMANDIE, Mont Saint Aignan Cedex (FR)

(21) Appl. No.: 18/874,725

(22) PCT Filed: Jun. 13, 2023
(86) PCT No.: PCT/EP2023/065743

§ 371 Date: Dec. 13, 2024

(30) Foreign Application Priority Data
Jun. 13, 2022 (FR) FR2205654

(51) Int. Cl. C04B 18/167; B01J 2/22; C04B 20/00; C04B 40/00; C04B 40/02

(52) U.S. Cl. CPC C04B 18/167; B01J 2/22; C04B 20/0016; C04B 40/0014; C04B 40/0231

(57) ABSTRACT

A method for recycling concrete waste from construction and/or deconstruction, including at least one step of microwave processing of concrete blocks, at least one step of mechanical processing, and at least one step of carbonation of recycled concrete aggregates and/or recycled concrete fines; and a recycling installation for carrying out the recycling method and to recycled concrete aggregates obtained by the steps of microwave processing of concrete blocks and mechanical processing.

### FIELD

The present invention relates to a method for recycling concrete waste from construction and/or deconstruction, comprising at least one step of microwave treatment of concrete blocks, at least one step of mechanical treatment, and at least one step of carbonation of recycled concrete aggregates and/or recycled concrete fines, the invention also relates to a recycling installation for carrying out the recycling method and to recycled concrete aggregates obtained according to the steps of microwave treatment of concrete blocks and mechanical treatment.

### BACKGROUND

Concrete is one of the world's most widely consumed manufactured materials. It comprises mainly aggregates (coarse and fine gravel), mixed with cement, sand, and water. In particular, France's annual consumption of aggregates is 350 million metric tons, or 6 metric tons per inhabitant per year and 17 kg per inhabitant per day. Projections show that demand for aggregates will continue to grow, especially for the construction of new buildings. Natural aggregates (NA) are generally obtained by mining alluvial, terrestrial, or marine sand and gravel deposits. Natural aggregates (NA) are not a renewable resource, and although they are technically unlimited, they are becoming less and less accessible for societal and environmental reasons. In particular, it is proving increasingly difficult to open new quarries to meet the demand for natural aggregates (NA), as these generate nuisances for nearby residents (noise, dust, increased traffic, etc.).

At the same time, the volume of materials generated by the deconstruction or demolition of buildings and infrastructures is increasing, and will continue to do so over the next few years. Indeed, buildings erected during the reconstruction of the 1950s are gradually reaching the end of their life cycle, which means that the volumes of concrete to be recycled will become considerable.

Moreover, the calcination of the natural limestone mineral resources needed to manufacture cement is responsible for almost half of the CO₂ emissions associated with the manufacture of concrete, one of the most CO₂-emitting materials produced by man.

Recycling concrete or masonry materials (e.g. construction and demolition waste) has been proposed as a way of avoiding landfill, reducing dependence on natural deposits, and manufacturing new concrete structures while preserving natural aggregate resources.

Construction and demolition concrete waste is generally recycled by crushing concrete blocks to form recycled concrete aggregates (RCA). Screening can also be carried out to separate RCAs from fines. However, the recycling methods currently on offer are not entirely satisfactory. NA separation from residual mortar is far from optimized. The RCAs generally obtained are composed of NAs, mostly associated with a significant amount of residual mortar from the original concrete. In particular, a large proportion of the residual mortar is found among the NAs, either adhering to them or in the form of aggregates of a size at least equivalent to that of the natural aggregates, thus preventing the production of clean NAs. Given the high proportion of adherent cement paste, such RCAs are of mediocre quality compared with NAS: they have higher water absorption and weaker mechanical properties (lower impact resistance and/or higher friability) than NAs. Concrete manufactured from RCAs mixed under normal conditions loses its workability when transported in drums, and this can sometimes render it unfit for use once it reaches its destination. The current concrete standard NF EN 206/CN imposes a maximum proportion of RCAs to replace the natural aggregates in the manufacture of new concrete, and this proportion varies according to the type of RCA and especially the constituents thereof, as well as the exposure class of the structures to be built. Because of the poor quality of these RCAs, they are currently mainly used in low value-added structures, especially in road earthworks as low value-added backfill, as road capping layers or as quarry backfill. However, recycling capabilities in the road-building sector are not unlimited, and this form of downcycling does not satisfactorily meet the criteria of sustainable development.

In addition, crushing can significantly fracture the NAs, contributing to a reduction in the size of the NAs compared with their initial particle size distribution and an enrichment of the fines with NA fragments. Thus, the recycled fines obtained have a composition that makes them more difficult to recover and/or recycle. Finally, as a large proportion of the cement paste adheres to or is associated with the RCAs, the amount of fines produced is small in relation to the amount of mortar found in the concrete. Current industrial plants do not generally recover the fine fraction, which is considered a waste product.

Solutions have been proposed to improve the performance of the RCAs, and thus to move towards a standard enabling their proportion to be increased within a new concrete structure, especially one with high added value. Examples include polymer-based chemical treatment, the use of mineral reinforcing agents, or carbonation (e.g. use of bacteria to induce the formation of calcium carbonate).

In particular, international application WO2020/217232 describes a wet concrete mix comprising hydraulic cement, water and carbonated recycled concrete aggregates. Carbonated recycled concrete aggregates are obtained using a method that comprises at least one crushing step, at least one size separation step, and a carbonation step, whereby carbonation can be carried out at the same time as the crushing step or the size separation step, or after one of these steps. In the examples, the carbonation is carried out after crushing a mortar containing sand and cement to form coarse recycled concrete aggregates of 5-20 mm followed by exposure to an atmosphere enriched with carbon dioxide (CO₂) and having a relative humidity of 55-65%, to form carbonated recycled concrete aggregates. These carbonated recycled concrete aggregates are then mixed with sand, water, and cement to form new concrete. The recycled concrete aggregates of WO2020/217232 have the composition of a mortar (a mixture of sand and cement). The RCAs obtained after carbonation are unclean and are of poor quality compared with NAs.

In addition, some publications envisage the use of concrete fines directly in the cement raw meal, as a raw material for the manufacture of clinker. By way of example, Schoon et al. [Cement and Concrete Composites, 58, 2015, 70-80] describe the incorporation of recycled concrete fines (5-15%) into a cement raw meal as a replacement for conventional siliceous materials. Different technical configurations were used to separate the mortar fraction from the aggregates, and to separate the generated fines from the recycled sand. However, Schoon et al. point out that it is difficult to collect a large amount of fines.

As a result, there is still a need for recycling methods that make it possible to obtain recycled concrete aggregates that are as clean as possible (i.e. with as little residual mortar as possible) and/or that have improved quality, so that they can be used in greater proportion to form a new concrete structure. There is also a need for recycling methods that can produce larger amounts of good-quality recycled concrete fines. In particular, there is a need for recycling methods that make it possible to recycle all the recoverable parts of the concrete, i.e. both the natural aggregates (NA) and the mortar that surrounds them.

### SUMMARY

As a result, the aim of the present invention is to overcome the disadvantages of the prior art and, especially, to provide a method for recycling concrete waste from construction and/or deconstruction that makes it possible to access recycled aggregates RCA that have better quality, especially in terms of water absorption and/or mechanical properties, and/or a higher level of cleanliness; and recycled fines in greater amounts and/or of better quality, especially in terms of pozzolanic and/or hydraulic activity, the method being simple, industrially applicable, using abundant raw materials, and environmentally beneficial.

The first subject matter of the invention is a method for recycling concrete from construction and/or demolition, characterized in that it comprises at least the following steps:
i) one or more steps of microwave treatment of concrete blocks from construction and/or demolition with a size on the centimeter scale, to form microfractured concrete blocks,
ii) one or more steps of mechanical treatment making it possible to extract, from said microfractured concrete blocks, recycled aggregates (hereinafter referred to as RCAs) comprising bare natural aggregates (NA) and natural aggregates (NA) associated with an adherent residual cementitious matrix (or residual mortar); and recycled fines,
and in that it further comprises:
iii) one or more steps of carbonating the recycled aggregates, in the presence of carbon dioxide, to form carbonated recycled aggregates (hereinafter referred to as CRCAs), and/or
iv) one or more steps of carbonating the recycled fines, in the presence of carbon dioxide, to form carbonated recycled fines.

The method of the invention is simple, easy to carry out, and results in:
at the end of steps i), ii) and iii), carbonated recycled aggregates (CRCAs), the carbonated recycled aggregates being cleaner and/or having better quality, especially in terms of water absorption and/or mechanical properties; and/or
at the end of steps i), ii) and iv), carbonated recycled fines comprising a large amount of cement paste and/or having better quality, especially in terms of pozzolanic activity following the production, by the carbonation step, of amorphous silica that is particularly reactive in a cementitious medium.

The method can involve the carbonation of the RCAs [step iii)], the carbonation of the recycled fines [step iv)], or both the carbonation of the RCAs and of the recycled fines [steps iii) and iv)].

Furthermore, the method is industrially applicable, uses abundant raw materials (concrete waste from construction or demolition) and reduces environmental impact by making it possible to recycle unused construction concrete or demolition concrete, while guaranteeing the use or recovery of CO₂. The method of the invention is an integral concrete recycling method in that it recycles all the initial concrete, i.e. the natural aggregates (NA) as well as the fines.

The method is a method for recycling concrete from construction and/or demolition, especially in the building and public works sector. In other words, the concrete can be concrete waste from construction of buildings and/or pavement structures, scrap from concrete production, concrete from the demolition of buildings or pavement structures, or a mixture thereof.

### Definitions

The term “cement” is used in the invention to designate a hydraulic binder, that is, a finely ground inorganic material which, when mixed with water, forms a paste which sets and hardens by means of hydration reactions and processes, and which, after hardening, retains its strength and stability even under water (definition according to standard EN 197-1).

The term “cement paste” (also referred to hereinafter as “CP”) is used in the invention to designate a mixture of cement and water, which hardens by virtue of the hydration reaction. Cement paste may optionally contain one or more additives. The amount of cement paste adhering to the RCAs is a criterion of RCA cleanliness.

The term “concrete” is used in the invention to designate a mixture of cement, aggregates (sand and gravel), and water. This is the initial material containing all the constituents (aggregates and cement paste) that are to be recovered.

The term “natural aggregates (NA)” is used in the invention to designate natural sand and gravel particles produced by mining alluvial, terrestrial, or marine sand and gravel deposits.

The term “recycled concrete aggregates (RCA)” is used in the invention to designate sand and gravel particles produced from concrete and reused to replace NAs, to manufacture concrete or for any other application. In the invention, the term “recycled concrete aggregate (RCA)” is also referred to as “recycled aggregate”.

The term “carbonated recycled concrete aggregates (CRCA)” is used in the invention to designate concrete aggregates that are carbonated by a dedicated accelerated carbonation n the invention, the term “carbonated concrete aggregates (CRCA)” is also referred to as “carbonated recycled aggregates”.

The term “residual mortar” is used in the invention to designate a mixture of cement paste and NA of a size smaller than the mesh size of the RCA in question. Most of the residual mortar is found adhering to the surface of the RCA under consideration. The definition of residual mortar therefore varies according to the particle size fraction of the RCA under consideration. If G_{M} is the upper mesh size and Gₘ the lower mesh size of a particle size fraction G_{M}-Gm of RCA, then the residual mortar associated with this particle size fraction of RCA contains a mixture of cement paste and NA of size <Gₘ. In the invention, the term “residual mortar” is also referred to as “residual cementitious matrix”.

The term “fines” is used in the invention to designate a mixture of cement paste and NA of a size smaller than the smallest size Gₘ of the finest fraction of the RCAs produced by the concrete recycling method.

The term “accelerated carbonation” is used in the invention to designate a carbonation method that operates at a CO₂ concentration 250 to 12,000 times higher than that of the earth's atmosphere (415 ppm), resulting in carbonation kinetics on the scale of a few minutes, compared with years for natural carbonation. In the residual mortar, only the cement paste carbonates, as the NA contained in the residual mortar does not carbonate. In this invention, the term “carbonation” used alone is synonymous with “accelerated carbonation”. The term “accelerated carbonation” or “carbonation” is therefore opposed to the term “natural carbonation”.

In the RCAs of the invention, the terms “bare natural aggregates”, “clean natural aggregates”, and “clean RCAs” are synonymous. The bare natural aggregates in the RCAs of the invention preferably comprise less than 5 wt. % of CP, more preferably at most 4 wt. % of CP, and even more preferably at most 3 wt. % of CP, with respect to the total weight of the bare natural aggregates.

In the RCAs of the invention, the terms “natural aggregates associated with an adherent residual mortar”, “unclean natural aggregates”, and “unclean RCAs” are synonymous. The natural aggregates associated with an adherent residual mortar in the RCAs of the invention preferably comprise 5 wt. % to 30 wt. % of CP, more preferably 7 wt. % to 25 wt. % of CP, and even more preferably 10 wt. % to 20 wt. % of CP, with respect to the total weight of the natural aggregates associated with an adherent residual mortar.

### Step i)

The centimeter-scale concrete blocks from construction and/or demolition used in step i) comprise bare natural aggregates (i.e. natural aggregates not associated with an adherent residual cementitious matrix or free of an adherent residual cementitious matrix) such as gravel or sand (i.e., gravel or sand that are “bare” or not associated with, or free of, an adherent residual cementitious matrix), as well as natural aggregates such as gravel or sand, associated with an adherent residual cementitious matrix. In other words, the centimeter-scale concrete blocks from construction and/or demolition used in step i) comprise natural aggregates (NA) such as gravel and/or sand, and cement paste. Within said centimeter-scale concrete blocks from construction and/or demolition, the NAs are thus associated with cement paste to form said centimeter-scale blocks.

In the invention, the adherent residual cementitious matrix comprises, for example, cement, sand, water, and optionally one or more additives. Gravel or a mixture of sand and gravel can be used instead of sand. As explained above, the particle size fraction of the sand and/or gravel in the cementitious matrix is smaller than the particle size fraction of the natural aggregates NA with which said cementitious matrix is associated.

Step i) enables the formation of a primary network of fractures within the concrete blocks, and more particularly around the natural aggregates (NA) (textural release of the aggregates); then the formation of a secondary network of fractures in the cement paste CP of the cementitious matrix (physical release of the aggregates and dense fracturing of the cement paste CP). This leads to selective fracturing of the concrete, making it possible to separate the natural aggregates (NA) from the bulk of the CP of the cementitious matrix, without significantly damaging the natural aggregates (NA).

In other words, secondary fracturing produces a dense (secondary) network of microfractures that innervates the cement paste of the cementitious matrix, whether or not it adheres to the surface of the natural aggregates; it enables the cement paste of the cementitious matrix to be released in a fine particle size fraction, which favors the subsequent extraction step ii), as well as step iii) of carbonation of the cement paste of the cementitious matrix which is associated with certain natural aggregates and adheres to the surface thereof, and/or step iv) of carbonation of the cement paste provided in large amounts in the recycled fines.

The formation of the above-mentioned primary and secondary fracture networks thus facilitates the subsequent step ii) of selectively releasing the natural aggregates (NA) contained in the construction and/or demolition concrete, and as a result promotes the separation of the NAs from the fines, without thereby degrading the NAs.

In other words, the greater the number of microfractures per unit of volume in the cement paste of the cementitious matrix, the cleaner the recycled concrete aggregates (RCA) obtained (i.e. high content of NA and low content of residual cementitious matrix or adherent residual mortar content, or even no residual cementitious matrix or adherent residual mortar), the greater the amount of CP in the fines, and the more efficient the method, and especially the subsequent steps ii), iii) and iv).

Unlike a crusher, which fractures concrete randomly (as shown in FIG. 1), microwave treatment selectively weakens the cement paste CP in the cementitious phase, without significantly altering the structure of the natural aggregates NA. The integrity of the natural aggregates NA is therefore preserved, and at least 75 wt. % of the CP of the centimeter-scale concrete blocks from construction and/or demolition can then be found in the recycled fines by virtue of the combination of steps i) and ii).

The microwave treatment in step i) can be carried out with sufficient incident power to induce fracturing of the concrete blocks.

Preferably, the microwave treatment in step i) is carried out at a power ranging from 1 kW to 50 kW, preferably from 5 kW to 40 kW, and more preferably from 5 kW to 10 kW.

These powers are particularly suitable for treating 1 t/h of concrete blocks.

Preferably, the microwave treatment in step i) is carried out for a time (exposure time) ranging from about 30 s to about 10 min, and more preferably from about 1 min to about 5 min.

In the invention, the term “size on the centimeter scale” relating to the concrete blocks from construction and/or demolition preferentially means that the concrete blocks from construction and/or demolition have a size of at most about 10 cm, more preferably at most about 7 cm, and most preferably at most about 5 cm.

Preferably, the concrete blocks from construction and/or demolition have a size of at least about 1 cm, more preferably at least about 2 cm, and most preferably at least about 3 cm.

Step i) can be carried out by passing the concrete blocks through a microwave tunnel.

The microwave treatment i) can be carried out at a frequency ranging from about 915 MHz to about 2450 MHz, and more preferably at a frequency of about 915 MHz or about 2450 MHz. These frequencies are average frequencies with bounds of 902-928 MHz and 2400-2500 MHz, respectively.

The microwave treatment i) can be carried out continuously or in pulsed mode (for example, with symmetrical square-wave pulses lasting at least 1 second).

Progressive or stationary wave propagation modes can be used depending on the size of the concrete pieces to be treated (concrete pieces to be treated smaller than 5 cm: stationary waves; concrete pieces to be treated larger than 5 cm: progressive waves).

The microwave treatment i) can be carried out using guided waves or antennas inside reflective cavities.

The microwave treatment i) results in drying of the material, and the evaporated water can advantageously be recovered, especially for reuse in subsequent steps ii) to iv).

At the end of step i), the concrete blocks are said to be “microfractured”, due to the fact that the cement paste contained in said concrete blocks is massively microfractured. As a result, the concrete blocks obtained in step i) comprise a microfractured cement paste.

### Step ii)

During step ii), said microfractured concrete blocks resulting from step i) undergo one or more mechanical treatment steps.

By virtue of step i), a mechanical stress that favors shear forces during step ii) helps to propagate fractures, fragment the microfractured concrete blocks while limiting the fracturing of the NAs, and release recycled aggregates RCA comprising bare natural aggregates and natural aggregates associated with an adherent residual cementitious matrix as well as with the recycled fines.

Step ii) makes it possible to extract, from said microfractured concrete blocks, recycled aggregates RCA comprising bare natural aggregates and natural aggregates associated with an adherent residual cementitious matrix (or adherent residual mortar); as well as recycled fines. At the end of step ii), the recycled aggregates are separated from the recycled fines, and at least 75 wt. % of the CP contained in the initial concrete to be recycled is found in the recycled fines.

At the end of step ii), a fraction F₁ of recycled aggregates RCA is obtained, comprising bare natural aggregates and natural aggregates associated with an adherent residual cementitious matrix (or adherent residual mortar); and a fraction F₂ of recycled fines.

The recycled aggregates RCA preferably have a particle size of about 1 mm or more.

The bare natural aggregates preferably have a particle size of about 1 mm or more.

The natural aggregates associated with an adherent residual cementitious matrix (or adherent residual mortar) preferably have a particle size of about 1 mm or more.

According to one preferred embodiment of the invention, the bare natural aggregates (the natural aggregates associated with an adherent residual cementitious matrix or adherent residual mortar, respectively) are selected from gravel, sands with a particle size of about 1 mm or more, and a mixture thereof.

Gravel is generally defined as having a particle size greater than about 4 mm.

Sand is generally defined as having a particle size of 4 mm or less.

In the present invention, the particle size of the RCAs, gravel, and sand is determined by methods that are well known to a skilled person, especially by sieving (for example, according to standard NF EN 933-1) (laboratory method) or by screening (industrial method).

The adherent residual cementitious matrix (or adherent residual mortar) associated with the natural aggregates NA comprises natural aggregates NA preferably having a particle size of less than about 1 mm.

The recycled fines (fraction F₂) generally comprise cement paste and natural aggregates NA such as sand, preferably with a particle size of less than about 1 mm.

The recycled fines (fraction F₂) preferably have a particle size of less than 1 mm.

In the fraction F₂, the sand and the cement paste can be in mortar form, in individual forms, or in a mixture in mortar form and in individual forms.

Step ii-1)

Step ii) preferably comprises at least one step ii-1) of milling the microfractured concrete blocks.

Step ii-1) of milling the microfractured concrete blocks can be carried out using at least one percussive crusher (e.g. a jaw crusher, a gyratory crusher, a cone crusher, or an impact crusher), or a non-percussive crusher (e.g. a roller mill such as a single-roller or double-roller mill, or a high-pressure roller mill, also well known by the acronym HPRC for “High Pressure Roll Crusher”).

Preferably, step ii-1) of milling the microfractured concrete blocks is a non-percussive milling step. In this embodiment, step ii-1) of milling the microfractured concrete blocks preferably uses at least one non-percussive crusher.

A non-percussive crusher has the advantage of applying continuous compressive shearing action. It thus prevents excessive damage to the natural aggregates NA and/or preserves the integrity of their grading and mechanical properties.

The non-percussive crusher is preferably a roller mill, such as a single-roller or double-roller mill. The roller mill can have either smooth or toothed rollers.

The crusher-type roller mill can produce a particular maximum particle size corresponding to that of the natural aggregates NA found in the initial concrete to be recycled, by suitable adjustment of its operating parameters, in particular the feed rate, the rotation speed of the one or more rollers, the spacing between the rollers and/or the hydraulic pressure applied.

The spacing of the rollers is adapted to the maximum particle size of the original aggregates (i.e. the natural aggregates NA in the initial concrete to be recycled), especially to minimize the fragmentation thereof.

The method may comprise a plurality of milling steps ii-1), in particular by carrying out:
a plurality of milling steps ii-1) after the microwave treatment step i), or
a plurality of successive sequences of a microwave treatment step i) and a milling step ii-1).

When a plurality of milling steps ii-1) are carried out after step i), a series of non-percussive crushers such as roller mills can be used, making it possible to successively produce increasingly finer maximum particle sizes of the RCAs, by suitable adjustment of the operating parameters of successive crushers, in particular the feed rate, the roller rotation speed, the spacing of the rollers and/or the hydraulic pressure applied.

The spacing of the rollers can be continuously reduced, so as to produce increasingly smaller particle size of the RCA aggregates and obtain the cleanest possible RCA aggregates (i.e. high content of NAs and low content of residual adherent mortar or cementitious matrix), and thus to optimize the production of recycled fines.

When a plurality of successive sequences of steps i) and ii-1) are carried out, a single non-percussive crusher such as a roller mill can be used after each step i), making it possible to successively produce increasingly finer maximum particle sizes of the RCA, by suitable adjustment of the operating parameters thereof, in particular the feed rate, the rotation speed of the one or more rollers, the spacing of the rollers and/or the hydraulic pressure applied.

The milling step ii-1) is advantageously carried out in a dry process. The dry process is particularly suitable as the previous microwave treatment step i) contributes to drying the material.

By virtue of one or more milling steps ii-1), recycled aggregates RCA (natural aggregates with or without adherent residual cementitious matrix) are obtained which preferably have a particle size G_{M} (corresponding to the maximum particle size of the natural aggregates NA of the original concrete to be recycled) of at most about 45 mm, or of at most about 25 mm, or of at most about 11.2 mm, or of at most 8 mm, or of at most 4 mm, depending especially on the intended application and/or the particle size of the natural aggregates NA found in the initial concrete to be recycled (i.e. G_{M}≤45 mm, or G_{M}≤25 mm, or G_{M}≤11.2 mm or G_{M}≤4 mm).

Preferably, the recycled aggregates RCA obtained after the milling step (natural aggregates with or without adherent residual cementitious matrix) have a minimum particle size Gₘ of at least about 1 mm (Gₘ≥1 mm).

Step ii-2)

Step ii) may further comprise, especially after step ii-1), at least one screening step ii-2) (also referred to as sieving). This step ii-2) enables the RCA aggregates and fines to be sorted by particle size.

The screening step ii-2) can be carried out in a dry or wet process, preferably in a wet process.

The screening step ii-2) can be carried out using any type of vibrating, gyratory or rotary screen or sieve, preferably a rotary screen or a rotary gyratory sieve. A rotary screen is also referred to as a rotary sieve, rotary screen, trommel screen or trommel sieve.

The screening step ii-2) makes it possible to separate the fraction F₁ of recycled aggregates RCA from the fraction F₂ of recycled fines; and optionally to separate said recycled aggregates RCA according to their particle size within the fraction F₁.

The method preferably comprises a plurality of screening steps ii-2).

The one or more screens used during the one or more screening steps ii-2) comprise a mesh with an aperture suitable for allowing such separation.

The screen (or series of screens) preferably has a mesh size suited to the crusher (or series of crushers) used in step ii-1) or steps ii-1).

According to one preferred embodiment of the invention, step ii-2) comprises a first screening step ii-2a) making it possible to isolate the recycled aggregates RCA having a particle size G₁ such that Gₘ≤G₁≤G_{M}, or a particle size fraction G_{1′}-G₁ such that Gₘ≤G_{1′}<G₁≤G_{M}.

By way of example, the recycled aggregates RCA isolated (i.e. separated) during the first screening step ii-2a) have a particle size G₁ of at least about 4 mm.

By way of example, the recycled aggregates RCA isolated (i.e. separated) during the first screening step ii-2a) have a particle size G₁ of at most about 45 mm, or at most about 25 mm, or at most about 11.2 mm, or at most 8 mm, depending especially on the intended application and/or the particle size of the natural aggregates found in the initial concrete to be recycled.

By way of example, the first screening step ii-2a) can make it possible to isolate RCAs with a given particle size fraction: 4-8 mm, or 8-11.2 mm or 11.2-25 mm, or 25-45 mm.

The limits of the particle size fraction are given only as a guide, and any other limit may be used depending on the intended application and/or the particle size of the NAs found in the initial concrete to be recycled.

In the first screening step ii-2a), the recycled aggregates RCA with a particle size G₁ (fraction F₁ₐ) are separated from the recycled fines (fraction F₂ₐ), and optionally from the recycled aggregates RCA with a smaller particle size (fraction F_{1b}, fraction F_{1c}, etc.).

The recycled aggregates RCA with a particle size of G₁ comprise bare natural aggregates and natural aggregates associated with a residual cementitious matrix (residual mortar), preferably adhering to said natural aggregates.

Step ii-2) may further comprise a second screening step ii-2b) making it possible to isolate the recycled aggregates RCA having a particle size G₂ such that Gₘ≤G₂<G₁, or a particle size fraction G_{2′}-G₂ such that Gₘ≤G_{2′}<G₂≤G₁<G₁≤G_{M}.

By way of example, the isolated recycled aggregates RCA during the second screening step ii-2b) have a particle size G₂ of at most about 4 mm.

By way of example, when the first screening step ii-2a) made it possible to isolate RCAs having a particle size fraction of 4-8 mm, the second screening step ii-2a) can make it possible to isolate RCAs having a particle size fraction of 1-4 mm; when the first screening step ii-2a) has made it possible to isolate RCAs having a particle size fraction of 8-11.2 mm, the second screening step ii-2a) can make it possible to isolate RCAs having a particle size fraction of 4-8 mm; when the first screening step ii-2a) has made it possible to isolate RCAs having a particle size fraction of 11.2-25 mm, the second screening step ii-2a) can make it possible to isolate RCAs having a particle size fraction of 8-11.2 mm; when the first screening step ii-2a) has made it possible to isolate RCAs having a particle size fraction of 25-45 mm, the second screening step ii-2a) can make it possible to isolate RCAs having a particle size fraction of 11.2-25 mm.

Preferably, the recycled aggregates RCA isolated during the second screening step ii-2b) have a particle size G₂ of at least about 1 mm.

In the second screening step ii-2b), the recycled aggregates RCA having a particle size G₂ (fraction F_{1b}) are separated from the recycled fines (fraction F_{2b}), and optionally from recycled aggregates with a smaller particle size (fraction F_{1c}, etc.).

The recycled aggregates RCA with a particle size G₂ comprise bare natural aggregates and natural aggregates associated with a residual cementitious matrix (residual mortar), preferably adhering to said natural aggregates.

Step ii) may thus comprise one or more screening steps ii-2). In particular, one or more screening steps [steps ii-2a), ii-2b), ii-2c), etc.] may be required in order to separate the recycled aggregates RCA as far as possible from the recycled fines. This may depend especially on the particle size dispersion of the initial natural aggregates NA used in the construction and/or demolition concrete.

The method of the invention, and especially step ii), may comprise a plurality of milling steps ii-1) and a plurality of screening steps ii-2).

In this embodiment, step ii) may comprise:
a plurality of milling steps ii-1) followed by a plurality of screening steps ii-2), or
a plurality of successive sequences of a milling step ii-1) and a screening step ii-2).

Step ii) preferably comprises a plurality of successive sequences of a milling step ii-1) and a screening step ii-2).

At the end of step ii), and especially of steps ii-1) and ii-2), the isolated or recovered recycled aggregates RCA have a structure as close as possible to that of the natural aggregates NA of the original demolition and/or construction concrete.

The method of the invention resulting from steps i) and ii) thus makes it possible to obtain RCA aggregates with a high degree of cleanliness, as well as to obtain a large amount of fines since the vast majority of the RCAs has been freed of the residual mortar (and consequently of the cement paste that the mortar contains) adhering to the NAS.

After step ii), when the method comprises a plurality of screening steps ii-2), the method may further comprise a step during which the different fractions of fines from the different screening steps (F₂ₐ, F_{2b}, F_{2c}, etc.) are brought together.

The reuse of this large amount of fines from concrete construction and demolition waste, as a mineral additive to reduce the demand for cement of concrete and/or as a constituent of the raw meal used to produce cement, is a potential vector for reducing CO₂ emissions and the demand for natural resources of concrete for manufacturing same.

At the end of step ii), and especially of steps ii-1) and ii-2), the recycled concrete aggregates RCA obtained with a given particle size fraction, of 1 mm or more, preferentially comprise 65 wt. % to 95 wt. % of NAs with said given particle size fraction, more preferentially 70 wt. % to 90 wt. % of NAs with said given particle size fraction, and even more preferentially 75 wt. % to 85 wt. % of NAs with said given particle size fraction, with respect to the total weight of the RCAs with said given particle size fraction. This is also referred to as recovery rate.

Preferably, the RCAs obtained with a given particle size fraction, of 1 mm or more, comprise at most 10 wt. % of CP, preferentially at most 8 wt. % of CP, and even more preferentially at most 5 wt. % of CP, with respect to the total weight of the RCAs with said given particle size fraction.

Preferably, the recycled concrete aggregates RCA obtained with a given particle size fraction, of 1 mm or more, comprise 5 wt. % to 20 wt. % of NAs with a particle size smaller than said given particle size fraction, and more preferentially 7 wt. % to 15 wt. % of NAs with a particle size smaller than said given particle size fraction, with respect to the total weight of the RCAs with said given particle size fraction.

In particular, the recycled concrete aggregates RCA obtained with a given particle size fraction, of 1 mm or more, comprise 5 wt. % to 35 wt. % of residual mortar, preferentially 10 wt. % to 30 wt. %, and even more preferentially 15 wt. % to 25 wt. % of residual mortar, with respect to the total weight of the RCAs with said given particle size fraction.

The contents of CP, NA with said given particle size fraction, NA with a particle size smaller than said given particle size fraction, and residual mortar of the RCAs obtained with a given particle size fraction of 1 mm or more, as defined hereinbefore, are obtained by selectively dissolving the CP found in said RCAs with hydrochloric acid, weighing and measuring the various aforementioned constituents.

At the end of step ii), and especially of steps ii-1) and ii-2), the recycled fines are separated or recovered. They preferentially comprise at least 75 wt. % of the CP contained in the initial concrete to be recycled, whereas a crushing step optionally followed by screening step(s) of the prior art leads to recycled fines that contain less than 25 wt. % of the CP contained in the initial concrete to be recycled.

Preferably, the recycled fines further comprise NAs with a particle size of less than 1 mm.

In the recycled fines, the NAs with a particle size of less than 1 mm and the cement paste can be dissociated, associated or partially associated, and generally partially associated.

Steps i) and ii) of the method are so effective that very little cement paste remains adhering to the NAs in the RCAs. This makes it possible to optimize the subsequent carbonation step iii), especially by promoting the access and the diffusion of the carbon dioxide into the pore volume of the cement paste of the adherent residual cementitious matrix containing the carbonatable reactive phases, in particular portlandite, lime and calcium silicate hydrates (C—S—H).

Similarly, steps i) and ii) of the method are so efficient that the vast majority of the cement paste is found in the recycled fines in a very fine particle size and well innervated with microfractures. In particular, the recycled fines are in the form of particles of very fine particle size (at least 45 wt. %, with respect to the total weight of recycled fines recovered, have a particle size <0.25 mm) and are fully accessible for carbonation. This makes it possible to optimize the subsequent carbonation step iv), especially by promoting the access and the diffusion of the carbon dioxide into the pore volume of the cement paste containing the carbonatable reactive phases, in particular portlandite, lime and calcium silicate hydrates (C—S—H).

Finally, by virtue of the combination of steps i) and ii), the recycled aggregates obtained comprise only bare natural aggregates and natural aggregates associated with an adherent residual cementitious matrix, whereas a crushing step optionally followed by one or more screening steps leads to recycled aggregates with a high content of cementitious matrix, some recycled aggregates being composed solely of cementitious matrix (residual mortar), with little or no natural aggregates NA, to the detriment of the subsequent carbonation step.

The method of the invention is efficient in that it makes it possible to obtain RCAs with a high degree of cleanliness for each given particle size fraction of 1 mm or more.

In the RCAs of the invention, the mortar (CP+NA with a particle size smaller than said given particle size fraction) is heterogeneously distributed/adhered around the NAs with said given particle size fraction. In practice, this leads to obtaining a majority of clean RCAs (i.e. bare natural aggregates or clean natural aggregates) and a minority of unclean RCAs (i.e. natural aggregates associated with an adherent mortar or unclean aggregates).

In particular, at the end of step ii), and especially of steps ii-1) and ii-2), the recycled concrete aggregates RCA obtained with a given particle size fraction of 1 mm or more, preferentially comprise at least 50 wt. % of clean natural aggregates with said given particle size fractions (i.e. bare natural aggregates or clean RCAs with said given particle size fraction), more preferentially 55 wt. % to 85 wt. % of clean natural aggregates with said given particle size fraction (i.e. bare natural aggregates or clean RCAs with said given particle size fraction), and even more preferentially 60 wt. % to 75 wt. % of clean natural aggregates with said given particle size fraction (i.e. bare natural aggregates or clean RCAs with said given particle size fraction), with respect to the total weight of the RCAs with said given particle size fraction.

As a corollary, at the end of step ii), and especially of steps ii-1) and ii-2), the recycled concrete aggregates RCA obtained with a given size fraction of 1 mm or more preferably comprise a content of less than 50 wt. % of unclean natural aggregates with said given particle size fraction (i.e. natural aggregates associated with adherent residual mortar or unclean RCAs with said given particle size fraction), more preferentially 15 wt. % to 45 wt. % of unclean natural aggregates with said given particle size fraction (i.e. natural aggregates associated with adherent residual mortar or unclean RCAs with said given particle size fraction), and even more preferentially 25 wt. % to 40 wt. % of unclean natural aggregates with said given particle size fraction (i.e. natural aggregates associated with adherent residual mortar or unclean RCAs with said given particle size fraction), with respect to the total weight of the RCAs with said given particle size fraction.

The content of RCAs obtained with a given particle size fraction, of 1 mm or more, in clean RCAs and unclean RCAs as defined hereinbefore is obtained by optical and/or visual sorting to separate the clean RCAs and the unclean RCAs, followed by checking the proportion of CP in the clean RCAs and the unclean RCAs by selectively dissolving the CP found in said clean and unclean RCAs with hydrochloric acid, weighing and measuring.

The method of the invention may comprise a plurality of microwave treatment steps i), a plurality of milling steps ii-1), and a plurality of screening steps ii-2), and preferably a plurality of successive sequences of a microwave treatment step, a milling step ii-1), and a screening step ii-2).

### Step a)

The method may further comprise at least one step a) of cleaning the recycled aggregates RCA. This reduces the proportion of cementitious matrix (residual mortar) in the recycled aggregates RCA, contributes to an even higher cleanliness rate for the recycled aggregates RCA and increases the proportion of recycled fines recovered.

Step a) is preferably carried out by abrasion, especially using a rotary screen or a gyratory sieve.

Abrasion is a well-known mechanical method for surface cleaning.

Step a) is preferentially carried out after the milling step ii-1).

Step a) can be carried out at the same time as (i.e. concomitantly with) the screening step ii-2), before or after the screening step ii-2), and preferably at the same time as the screening step ii-2).

If steps a) and ii-2) are carried out concomitantly, they can be carried out using a rotary screen or a gyratory sieve.

If steps a) and ii-2) are not carried out concomitantly, the abrasion step a) can be carried out in a rotating drum, with or without lifters.

If a plurality of screening steps are carried out (e.g. step ii-2a) and ii-2b)), the method may comprise a plurality of cleaning steps a), especially concomitant with each of the screening steps, before or after each of the screening steps.

To facilitate step a), and especially to facilitate abrasion of the cementitious matrix (residual mortar), natural aggregates NA can be added to the recycled aggregates RCA prior to step a).

The natural aggregates NA added can represent up to 99.5 wt. %, preferably up to 95 wt. %, and more preferably up to 50 wt. %, with respect to the total weight of aggregates (NA+RCA) used in step a).

### Step b)

The method may further comprise at least one step b) of washing the recycled aggregates RCA. This reduces the proportion of sand and cement paste (fines) residues in the recycled aggregates RCA (i.e. which could adhere to the surface of the RCAs).

Step b) is preferably carried out by washing with water, and more preferably by sprinkling or spraying with water.

Step b) can be carried out at the same time as (i.e. concomitantly with) the cleaning or abrading step a), and/or at the same time as the screening step ii-2), and/or between the cleaning or abrading step a) and the screening step ii-2), and preferably at the same time as the screening step ii-2) and optionally at the same time as the cleaning or abrading step a).

This also makes it possible to promote the entrainment of the recycled fines and the separation thereof from the recycled aggregates RCA.

If a plurality of screening steps are carried out (e.g. steps ii-2a) and ii-2b)), the method may comprise a plurality of washing steps b), especially concomitant with each of the screening steps ii-2) and/or cleaning steps a), or between each of the cleaning steps a) and the screening steps ii-2).

According to one preferred embodiment of the invention, steps ii-2) and a) are carried out at the same time, especially using a rotary screen or gyratory sieve, and particularly preferably in a wet process. The wet process is preferably carried out by sprinkling or spraying water (e.g. water spray, which can reuse the water evaporated and then condensed in step i). In other words, in this wet process, steps ii-2), a) and b) are carried out at the same time. This eliminates the recycled fines that could adhere to the surface of the natural aggregates, preventing them from being entrained in the recycled aggregates (RCA), and thus concentrating them in the final fraction of recycled fines. Step iv) of the method of the invention is optional in that it is possible to carbonate only the RCAs at the end of step ii) according to step iii) (first variant). The recycled fines obtained at the end of step ii) can then be used directly in the cement raw meal, for example for the manufacture of calcium clinker, by means of compositional adjustments (e.g. to achieve particular silicon or hydraulic moduli) by adding other sources of materials used in the raw meal. By substituting a fraction of the natural limestone used in the cement raw meal, the use of recycled fines in cement raw meal contributes to the preservation of natural limestone resources, and reduces the carbon footprint of clinker by not emitting any additional CO₂ during the clinkering step, compared to the use (calcination) of natural limestone.

Step iii) of the method of the invention is optional in that it is possible to carbonate only the recycled fines at the end of step ii) according to step iv) (second variant). Indeed, steps i) and ii) result in RCAs that are so clean that carbonation iii) may not be necessary (low CP content of the RCAs obtained with a given particle size fraction of 1 mm or more).

The RCAs obtained at the end of step ii) can be used directly in the preparation of new concretes. They comprise such a low proportion of residual mortar that their water absorption and abrasion properties are 2 to 3 times better than those of the RCAs obtained by the methods of the background art.

In a third variant of the method, the recycled fines and the RCAs are carbonated. This makes it possible to recover/store a greater amount of CO₂ and to further improve the properties of the RCAs.

Step iii)

The method may further comprise one or more steps iii) of carbonation in the presence of carbon dioxide of the RCAs [corresponding to the fraction F₁ recovered at the end of step ii), ii-1), ii-2), ii-2a), or ii-2b)].

Step iii) enables the carbonation in the presence of carbon dioxide of the recycled aggregates RCA obtained in the previous step ii), and in particular the carbonation in the presence of carbon dioxide of the recycled aggregates RCA having one or more of the particle sizes described in the invention, especially having one or more particle sizes ranging from Gₘ to G_{M}, G₁ and/or G₂.

During step iii), the CP adhering to the surface of the RCAs is carbonated.

At the end of step ii), and especially of steps ii-1) and ii-2), the RCAs comprise NAs associated with a small amount of CP innervated in its volume by a microporosity resulting from step i). This makes it possible to optimize the carbonation step iii), especially by promoting the access and the diffusion of the carbon dioxide into the volume of cement paste containing the carbonatable reactive phases, in particular portlandite, lime and calcium silicate hydrates (C—S—H).

Step iii) is preferably carried out in the presence of a gas containing CO₂, preferably comprising at least 1 mol. % of CO₂, more preferably at least 10 mol. % of CO₂, and most preferably at least 15 mol. % of CO₂, with respect to the total number of moles of gas.

Step iii) is preferably carried out in the presence of a gas containing CO₂, preferably comprising at least 5 vol. % of CO₂, and more preferably at least 10 vol. % of CO₂, with respect to the total volume of gas.

The carbon dioxide can come from fumes containing CO₂, for example from a biogas stream that is rich in CO₂, generated by a methanizer or biomass power plant, or for example from a fume produced by an industrial emitter such as a cement plant or thermal power plant; or be prepared from a source of CO₂. The source of CO₂ may or may not be stored beforehand.

The fumes containing CO₂ preferably contain at least 15 mol. % of CO₂, with respect to the total number of moles of gas found in the fumes, or at least 15 vol. % of CO₂, with respect to the total volume of gas found in the fumes.

The fumes containing CO₂ may also contain other elements, in particular molecular nitrogen N₂, molecular oxygen O₂, and optionally water.

The biogas stream may contain from about 70 mol. % to about 90 mol. % of CO₂, with respect to the total number of moles of biogas, or from about 70 vol. % to about 90 vol. % of CO₂, with respect to the total volume of biogas.

During step iii), the recycled aggregates RCA can be introduced into a rotating drum or other reactor, where they can be brought into contact with the gas containing carbon dioxide.

Step iii) can be carried out with a partial pressure of CO₂ ranging from about 0.1 bar to about 100 bar, and preferably from about 0.1 bar to about 5 bar (i.e. about 250 to 12,000 times the partial pressure of 415 ppm of CO₂ in the earth's atmosphere).

Step iii) can be carried out at a temperature ranging from about 18° C. to about 100° C., and preferably from about 20° C. to about 80° C.

Step iii) can be carried out with a relative humidity ranging from about 0% to about 100%, preferably from about 10% to about 90%, and even more preferably from about 40% to about 70%.

At the end of step iii), the carbonated recycled aggregates or CRCAs comply with standard NF EN 12620, especially in terms of water absorption, and/or fragmentation resistance, and/or density after oven drying, and/or abrasion resistance, and preferentially at least in terms of water absorption and abrasion resistance.

By virtue of carbonating recycled aggregates RCA, carbonated recycled aggregates CRCAs of homogeneous and improved quality are obtained, which can be used to prepare new concrete, especially for the manufacture of a new structure. Steps ii-2) and iii) may be carried out concomitantly.

Carbonation is directed to the reactive phases, i.e. the cement paste CP of the adherent residual cementitious matrix. At the end of step iii), the carbonated recycled aggregates or CRCAs are obtained, comprising bare natural aggregates and natural aggregates associated with a residual cementitious matrix in which the cement paste is carbonated, preferably adhering to the natural aggregates NA.

### Step iv)

The method may further comprise one or more steps iv) of carbonation in the presence of carbon dioxide of the recycled fines [corresponding to the fraction F₂ recovered at the end of step ii), ii-1), ii-2), ii-2a), or ii-2b)].

Carbonation is directed to the reactive phases, i.e. the CP found in the recycled fines. At the end of step iv), the result is carbonated recycled fines comprising a mixture of NA<1 mm and carbonated CP.

The carbonation of the recycled fines makes it possible to store carbon dioxide, as well as to obtain carbonated fines potentially having pozzolanic and/or hydraulic activity. They can then be used as a mineral additive in concrete to replace a cement (for example, CEM I or CEM II), or as a cement constituent with a view to manufacturing blended cements. By replacing Portland cement, for example, in the formulation of structural concretes (buildings) or non-structural concretes (cinder blocks, blocks, slabs, coping stones, technical mortars), the use of carbonated fines as a mineral additive reduces the carbon footprint of the concrete. This reduction originates from the lower proportion of Portland cement in the concrete, and from the amount of carbon trapped in the carbonate fines, which then act as a carbon sink.

In other words, the carbonated recycled fines obtained according to the method described hereinbefore can be used as a means for storing CO₂ and/or as a replacement for all or part of a cement. This use of the carbonated fines as a reactive mineral additive in the concrete formulation reduces the carbon footprint of the concrete in proportion to the rate at which cement is replaced by the carbonated fines.

When the recycled fines originating from step ii) are used as a mineral additive, they are preferably milled prior to the carbonation step iv), for example until obtaining a particle size of less than about 80 μm, preferably between about 5 μm and about 20 μm.

Step iv) is preferably carried out in the presence of a gas containing CO₂, preferably comprising at least 1 mol. %, more preferably at least 5 mol. % of CO₂, and most preferably at least 10 mol. % of CO₂, with respect to the total number of moles of gas.

Step iv) is preferably carried out in the presence of a gas containing CO₂, preferably comprising at least 5 vol. %, and more preferably at least 10 vol. % of CO₂, with respect to the total volume of gas.

The carbon dioxide can come from fumes containing CO₂, for example from a biogas stream that is rich in CO₂, generated by a methanizer or biomass power plant, or for example from a fume produced by an industrial emitter such as a cement plant or thermal power plant; or be prepared from a source of CO₂. The source of CO₂ may or may not be stored beforehand.

The fumes containing CO₂ preferably contain at least 10 mol. % of CO₂, with respect to the total number of moles of gas found in the fumes, or at least 10 vol. % of CO₂, with respect to the total volume of gas found in the fumes.

The fumes containing CO₂ may also contain other elements, in particular molecular nitrogen N₂, molecular oxygen O₂, and optionally water.

The biogas stream may contain from about 70 vol. % to about 90 vol. % of CO₂, with respect to the total volume of biogas, or from about 70 mol. % to about 90 mol. % of CO₂, with respect to the total number of moles of biogas.

During step iv), the recycled fines can be introduced into a rotating drum or any other reactor, where they can be brought into contact with the gas containing carbon dioxide.

Step iv) can be carried out with a partial pressure of CO₂ ranging from about 0.1 bar to about 100 bar, and preferably from about 0.1 bar to about 5 bar (i.e. 240 to 12,000 times the partial pressure of CO₂ in the atmosphere—0.415 millibar).

Step iv) can be carried out at a temperature ranging from about 18° C. to about 100° C., and preferably from about 20° C. to about 80° C.

Step iv) can be carried out with a relative humidity ranging from 0% to about 100%, and preferably from about 10% to about 90%.

Accelerated carbonation of the fines produces carbonated recycled fines that can store up to about 15 wt. % of CO₂, i.e. up to about 150 kg of CO₂ per metric ton of fines.

### Step i₀)

The method may further comprise, prior to step i), a step i₀) of crushing a construction and/or demolition concrete to form the concrete blocks from construction and/or demolition with a size on the centimeter scale such as that carried out in step i).

The crushing step i₀) can be carried out using a crusher such as a gravel crusher or jaw crusher, a cone crusher, a gyratory crusher, a percussive crusher, an impact crusher, a hammer crusher, or a centrifugal rotor crusher.

According to one preferred embodiment of the invention, step i) is performed directly after step i₀) (no intermediate step(s)).

According to one preferred embodiment of the invention, the method does not comprise any step(s) involving a liquid phase between step i₀) and step i).

The method of the invention makes it possible to obtain, from concrete blocks from construction and/or demolition, a distribution between aggregates and fines that is close to the initial distribution of the original concrete, i.e. about 70 wt. % to 90 wt. % of recycled aggregates RCA or carbonated recycled aggregates CRCA (fraction F₁, carbonated or not), and 10 wt. % to 30 wt. % of fines (fraction F₂, carbonated or not), with respect to the total weight of concrete blocks from construction and/or demolition, it being understood that at least one of the fractions F₁ or F₂ is carbonated.

In particular, the combined use of microwaves, mechanical treatment and carbonation of the fines and/or the RCAs in the presence of carbon dioxide makes it possible to recycle concrete waste from construction and/or deconstruction.

The second subject matter of the invention is a recycling installation carrying out a recycling method according to the first subject matter of the invention, characterized in that it comprises:
at least one microwave tunnel for forming microfractured concrete blocks from concrete blocks from construction and/or demolition with a size on the centimeter scale,
at least one roller mill for fragmenting the microfractured concrete blocks and releasing recycled aggregates (RCA) comprising bare natural aggregates and natural aggregates associated with an adherent residual cementitious matrix; and recycled fines,
at least one vibrating, gyratory or rotary screen or sieve for separating the recycled aggregates from the recycled fines, optionally cleaning them and optionally washing them, and
at least one carbonation reactor for forming carbonated recycled aggregates (CRCA) and/or carbonated recycled fines.

The rotary or gyratory screen is preferred for separating the recycled aggregates from the recycled fines, cleaning and washing them.

The various elements used in the system are as defined in the first subject matter of the invention.

The third subject matter of the invention is a method for recycling concrete from construction and/or demolition, characterized in that it comprises the following steps:
i) one or more steps of microwave treatment of concrete blocks from construction and/or demolition with a size on the centimeter scale, to form microfractured concrete blocks, and
ii) one or more steps of mechanical treatment making it possible to extract, from said microfractured concrete blocks, recycled aggregates (RCA) comprising bare natural aggregates and natural aggregates associated with an adherent residual cementitious matrix (or residual mortar); and recycled fines,
said method lacking steps iii) and iv) as defined in the invention (i.e. step(s) of carbonating the RCAs and the recycled fines obtained in step ii)).

As explained hereinbefore in the first subject matter of the invention, the combination of steps i) and ii), and especially steps i), ii-1) and ii-2), makes it possible to obtain recycled aggregates RCA with a structure as close as possible to that of the natural aggregates NA of the initial demolition and/or construction concrete, thus having a high degree of cleanliness.

The method according to the third subject matter of the invention resulting from steps i) and ii) thus makes it possible to obtain RCA aggregates with a high degree of cleanliness, as well as to obtain a large amount of fines since the vast majority of the RCAs has been freed of the residual mortar (and consequently of the cement paste that the mortar contains) adhering to the NAs.

Steps i) and ii) of the method according to the third subject matter of the invention are so effective that very little cement paste adheres to the NAs in the RCAs. Similarly, steps i) and ii) of the method according to the third subject matter of the invention are so efficient that the vast majority of the cement paste is found in the recycled fines in a very fine particle size.

Step ii) preferably comprises at least one step ii-1) of milling the microfractured concrete blocks. The method may comprise a plurality of milling steps ii-1).

Step ii) may further comprise, especially after step ii-1), at least one screening step ii-2). Step ii) may comprise one or more screening steps ii-2).

The method of the invention, and especially step ii), may comprise a plurality of milling steps ii-1) and a plurality of screening steps ii-2).

The method may further comprise at least one step a) of cleaning the RCAs.

The method may further comprise at least one step b) of washing the RCAs.

The method may further comprise, prior to step i), a step i₀) of crushing a construction and/or demolition concrete to form the concrete blocks from construction and/or demolition with a size on the centimeter scale such as that carried out in step i).

Steps i), ii), ii-1), ii-2), a), b), and i₀) of the method according to the third subject matter of the invention are as defined in the first subject matter of the invention.

The method according to the third subject matter of the invention therefore makes it possible to isolate the RCAs obtained directly in step ii). In other words, it corresponds to a method for manufacturing RCAs.

The recycled fines obtained at the end of step ii) of the method according to the third subject matter can be used directly in the cement raw meal, for example for the manufacture of calcium clinker, by means of compositional adjustments (e.g. to achieve particular silicon or hydraulic moduli) by adding other sources of materials used in the raw meal. By substituting a fraction of the natural limestone used in the cement raw meal, the use of recycled fines in cement raw meal contributes to the preservation of natural limestone resources, and reduces the carbon footprint of clinker by not emitting any additional CO₂ during the clinkering step, compared to the use (calcination) of natural limestone.

The RCA obtained at the end of step ii) of the method according to the third subject matter can be used directly in the preparation of new concrete.

The fourth subject matter of the invention is recycled aggregates (RCA) obtained by a method according to the first subject matter of the invention or obtained by a method according to the third subject matter of the invention, characterized in that the RCAs with a given particle size fraction, of 1 mm or more, comprise at least 50 wt. % of clean natural aggregates with said given particle size fraction (i.e. bare natural aggregates or clean RCAs with said given particle size fraction), more preferentially 55 wt. % to 85 wt. % of clean natural aggregates with said given particle size fraction (i.e. bare natural aggregates or clean RCAs with said given particle size fraction), and even more preferentially 60 wt. % to 75 wt. % of clean natural aggregates with said given particle size fraction (i.e. bare natural aggregates or clean RCAs with said given particle size fraction), with respect to the total weight of the RCAs with said given particle size fraction.

As a corollary, the recycled concrete aggregates RCA, of 1 mm or more, preferably comprise a content of less than 50 wt. % of unclean natural aggregates with said given particle size fraction (i.e. natural aggregates associated with adherent residual mortar or unclean RCAs with said given particle size fraction), more preferentially 15 wt. % to 45 wt. % of unclean natural aggregates with said given particle size fraction (i.e. natural aggregates associated with adherent residual mortar or unclean RCAs with said given particle size fraction), and even more preferentially 25 wt. % to 40 wt. % of unclean natural aggregates with said given particle size fraction (i.e. natural aggregates associated with adherent residual mortar or unclean RCAs with said given particle size fraction), with respect to the total weight of the RCAs with said given particle size fraction.

In particular, the RCAs with a given particle size fraction of 1 mm or more comprise at most 10 wt. % of CP, preferentially at most 8 wt. % of CP, and even more preferentially at most 5 wt. % of CP, with respect to the total weight of the RCAs with said given particle size fraction.

The recycled concrete aggregates RCA with a given particle size fraction of 1 mm or more preferentially comprise 65 wt. % to 95 wt. % of NA with said given particle size fraction, more preferentially 70 wt. % to 90 wt. % of NA with said given particle size fraction, and even more preferentially 75 wt. % to 85 wt. % of NA with said given particle size fraction, with respect to the total weight of the RCAs with said given particle size fraction.

Preferably, the recycled concrete aggregates RCA with a given particle size fraction, of 1 mm or more, comprise 5 wt. % to 20 wt. % of NA with a particle size smaller than said given particle size fraction, and more preferentially 7 wt. % to 15 wt. % of NA with a particle size smaller than said given particle size fraction, with respect to the total weight of the RCAs with said given particle size fraction.

In particular, recycled concrete aggregates RCA with a given particle size fraction, of 1 mm or more, comprise 5 wt. % to 35 wt. % of residual mortar, preferentially 10 wt. % to 30 wt. %, and even more preferentially 15 wt. % to 25 wt. % of residual mortar, with respect to the total weight of the RCAs with said given particle size fraction.

### BRIEF DESCRIPTION OF THE DRAWINGS

The appended drawings illustrate the invention:

FIG. 1a shows the fracturing of concrete according to a method of the background art.

FIG. 1b shows the fracturing of concrete comparatively according to the method of the invention.

FIG. 2 depicts a schematic diagram of the various steps of the method of the invention.

FIG. 3 depicts the measurement of RCA cleanliness through the variation in residual CP (wt. %) depending on the size of the RCAs; and the measurement of RCA water absorption (as a %) depending on the size of the RCAs, according to the method of the invention, and comparatively according to a reference method.

FIG. 4a depicts the speciation analysis of the constituents of the initial concrete and RCAs at the end of the method of the invention.

FIG. 4b depicts comparatively the speciation analysis of the constituents of the initial concrete and RCAs of a reference method.

FIG. 5 shows the performance of the method of the invention with respect to a reference method, and with respect to the theoretical limit.

FIG. 6 shows the performance of the method of the invention with respect to a reference method, and with respect to the theoretical limit.

### DETAILED DESCRIPTION

Further features and advantages of the present invention will become apparent from the description of non-limiting examples of the method according to the invention.

### EXAMPLES

### Example 1: Depictions of the Method According to the Invention and of a Method of the Background Art not According to the Invention

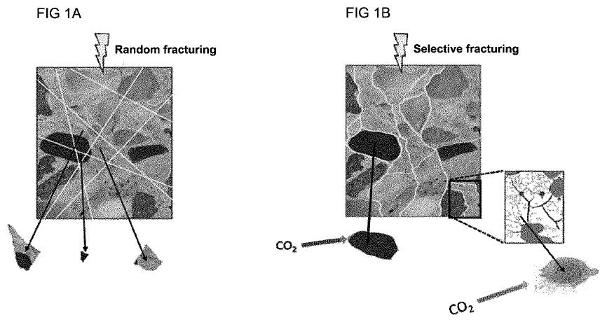

FIG. 1 comprises a depiction of concrete fracturing according to a method of the background art (FIG. 1a)) and a representation of concrete fracturing using the method of the invention (FIG. 1b)).

In FIG. 1a), the fracturing is random and non-selective between the NAs and the mortar. It produces RCAs with low NA content (<60 wt. % of NA with respect to the total weight of the RCAs) and with high CP content (>10 wt. % of CP with respect to the total weight of the RCAs), with a high potential for transgranular fracturing of the original natural aggregates NA. As a result, aggregates made entirely of cementitious matrix can be formed, while natural aggregates NA with their original structure preserved are released only to a limited extent. After fracturing, one type of recycled concrete aggregates (RCA) is mostly obtained: mixed aggregates composed of pieces of natural aggregate and a high proportion of cementitious matrix or mortar within the mixed aggregates. As a corollary, fracturing produces few recycled fines, which concentrate no more than 25% of the CP of the initial concrete to be recycled.

In FIG. 1b), the fracturing of a concrete according to the method of the invention is selective between the NAs and the mortar, thus avoiding fracturing of the original natural aggregates NA, and favoring the release of natural aggregates NA with their original structure preserved, as well as of the cementitious matrix. The cement paste in the microfractured cementitious matrix can lead to fines, which may or may not be carbonated, with a particle size that is easily separable from that of the aggregates. On the surface of the released natural aggregates, a small proportion of adherent residual cementitious matrix may be found, which may or may not be carbonated to obtain recycled aggregates RCA or carbonated recycled aggregates CRCA that perform as well as the original natural aggregates. In other words, the fracturing of a concrete according to the method of the invention favors both the concentration of the NAs in RCAs with a low content of adherent mortar without altering the particle size and mechanical properties of the NAs, and the recovery of the CP contained in the initial concrete to be recycled in a fines fraction. The microfracturing of the CP concentrates most of the CP from the initial concrete to be recycled in the fines, and promotes the carbonation of the CP in the fines and/or of the CP adhering in small amounts to the surface of the RCAs. The carbonation of the RCAs produces CRCAs with performance levels as good as those of the NAs.

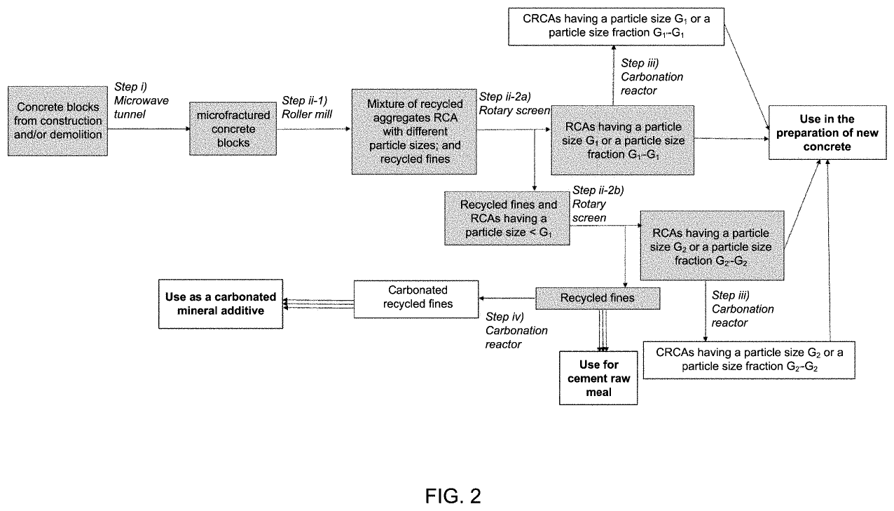

FIG. 2 shows step i) of microwave treatment in a microwave tunnel of concrete blocks from construction and/or demolition in order to form microfractured concrete blocks. These are then milled in step ii-1) in a roller mill to form a mixture of recycled aggregates RCA with different particle sizes; and recycled fines. Milling ii-1) makes it possible to obtain a particle size of 8 mm or less, for example. A first screening or sieving step ii-2a) is then carried out using a rotary screen to extract recycled aggregates having a particle size fraction G_{1′}-G₁ (e.g. particle size fraction of 4 mm to 8 mm); as well as a mixture of recycled fines and recycled aggregates having a particle size<G₁ (particle size of less than 4 mm).

Clean recycled aggregates RCA having a particle size fraction G_{1′}-G₁ are then carbonated in a step iii) in a carbonation reactor in order to form a first CRCA fraction. The recycled fines and the recycled aggregates having a particle size<G₁ undergo a further screening or sieving step ii-2b) using a rotary screen to extract recycled aggregates RCA having a particle size fraction G_{2′}-G₂ (e.g. particle size or particle size fraction of 1 mm to 4 mm); as well as recycled fines (particle size of less than 1 mm).

The clean recycled aggregates having a particle size fraction G_{2′}-G₂ are then carbonated in a step iii) in a carbonation reactor in order to form a second CRCA fraction and/or the recycled fines are carbonated in a carbonation reactor in a step iv).

Optionally, the concrete blocks used in step i), having a size on the centimeter scale (e.g. ≤30 mm), can be obtained from the crushing of construction and/or demolition concrete, preferably using a gravel crusher or jaw crusher [step i₀)].

During steps ii-2a) and ii-2b), steps of abrasion a) and washing b) (water spraying) are preferably carried out concomitantly with each of steps ii-2a) and ii-2b).

### Example 2: Recycling of Concrete from Construction and/or Demolition Using a Method According to the Invention

### 2.1 Production of Concrete Samples and Characteristics

A concrete was formulated from cement and crushed siliceous natural aggregates (NA) with a particle size of less than 8 mm and a water/cement ratio of 0.6.

2.1.1 The cement used is Lafarge CEM I from the Le Teil plant. Its strength class is 52.5R, that is, rapid-setting. It meets the European requirements of standard EN 197-1.

The physical and mechanical characteristics of the cement used are as follows:

$$Blaine specific surface area = 4160 {cm}^{2} \text{/g} , and$$

$$Density = 3.15 g / {cm}^{3} .$$

2.1.2 The natural aggregates (NA) used are a mixture of sand(S) and gravel (G) from the Palvadeau sandpit (Saint-christophe-du-Ligneron) of the crushed siliceous type. The characteristics of these aggregates are as follows:

$$Density = 2640 \text{kg/} {m}^{3} ,$$

$$Absorption coefficient = 0.7 \% ,$$

$$Chlorides < 0.001 \% ,$$

$$\text{Water-soluble} sulfates < 0.01 \% , and$$

$$Active alkali content = 0.0022 \% .$$

Table 1 hereunder depicts the particle size distribution of the NAs used to formulate the concrete, and more particularly the wt. % (mass fractions) of five different particle size fractions, namely 4/8 mm, 2/4 mm, 1/2 mm, 0.25/1 mm and 0/0.25 mm, with respect to the total weight of the natural aggregates NA used to formulate the concrete.

TABLE 1

| NA particle | | Mass fraction |
|---|---|---|
| size fraction | Nomenclature | (wt. %) |
| 4/8 mm | 4/8 NA | 51.2 |
| 2/4 mm | 2/4 NA | 12.9 |
| ½ mm | ½ NA | 7.4 |
| 0.25/1 mm | 0.25/1 NA | 14.2 |
| 0/0.25 mm | 0/0.25 NA | 14.3 |
| Total | | 100.0 |
| 0/1 mm | <1 NA | 28.5 |

These mass fractions are interpreted as average values of the actual NA composition of the concrete used hereinafter. The last line of table 1 defines the 0/1-mm NA particle size fraction which is referred to hereunder. This fraction combines the 0.25/1-mm and 0/0.25-mm NA.

### 2.1.3 Concrete Formulation

The proportions of binder (cement and superplasticizer), water and NA used to produce concrete are shown in table 2 hereunder:

TABLE 2

| CEM I | 280 kg/m³ | Concrete | Mass |
|---|---|---|---|
| metering | of concrete | constituents | fraction (%) |
| Water/cement | 0.6 | CEM I | 11.8 |
| mass ratio | | | |
| Gravel/sand | 1.33 | Water | 7.6 |
| mass ratio | | | |
| Superplasticizer | 0.3 wt. %, with respect | NA | 80.6 |
| | to the total weight of | | |
| | water + cement + NA + | | |
| | superplasticizer | | |

A plurality of concrete samples are prepared by mixing the constituents in a mortar mixer for 60 seconds at low speed (62 rpm), 40 seconds at high speed (125 rpm), pausing for 90 seconds and then 60 seconds at high speed (125 rpm) to form a mixture; then pouring the mixture into gray polypropylene cylindrical molds with a diameter of 25 mm and a height of 30 mm. The molds are vibrated for 2×10 seconds on a vibrating table. This leads to the formation of a plurality of concrete cylinders of controlled composition and shape, with a size of about 30 mm in their largest dimension.

These concrete cylinders are then stored under cellophane in a room tempered to 19° C. for 28 days to cure the concrete.

After curing for 28 days in a temperate room, the cylindrical concrete samples are oven-dried at 80° C. for 48 hours. This time was determined following a test on a batch of aggregates weighed at regular intervals until reaching a constant mass (Δm<0.1%). This drying method ensures reproducibility of the concrete samples produced, by giving them a controlled moisture content comparable to that of naturally aged concrete.

The composition of the concrete in the samples, after curing and storage, is measured by dissolving the CP in 19 wt. % hydrochloric acid. The values in table 3 hereunder show the range of composition values measured on a plurality of 30-mm concrete samples, each sample being dissolved individually. This makes it possible to assess the variability in the composition of the concrete samples used.

TABLE 3

| Concrete | Mass fraction | Average mass |
|---|---|---|
| constituents | (%) | fraction (%) |
| 4/8 NA | 41.7-50.9 | 44.9 |
| 2/4 NA | 8.7-14.5 | 11.7 |
| ½ NA | 5.1-6.6 | 6.0 |
| 0.25/1 NA | 9.4-12.1 | 10.4 |
| 0/0.25 NA | 8.8-13.1 | 11.0 |
| CP (hardened | 14.1-17.1 | 16.1 |
| cement + water) | | |
| Total | | 100 |
| Mortar (CP + <1 NA) | 32.3-42.3 | 37.5 |

### 2.2 Implementation of the Method of the Invention

### 2.2.1 Microwave Fracturing Step i)

The microwave bench used is a single-mode cavity waveguide manufactured by SAIREM with the following characteristics:

$$Frequency = 2450 \pm 25 MHz ,$$

$$Output power = 2000 \pm < 0.1 \% W ,$$

$$Maxiumum operating power = 1700 W ,$$

$$Waveguide = WR 340 ( rectangular section 86 ⨯ 43 mm ) ,$$

$$Wave ripple < 0.3 \% RMS , and$$

$$Magnetron cooling \text{system:} water .$$

This microwave bench can treat one 30-mm concrete sample at a time, at a given power and for a given time. A cylindrical concrete sample is placed in a quartz tube, which acts as a sample holder, with the tube placed in the chimney of the microwave bench. Each sample is treated for 4 minutes with an incident microwave power of 1.5 KW. The temperatures reached on the concrete surface range from 450° C. to over 600° C. (limit measurable by the infrared thermometer used).

### 2.2.2 Mechanical Processing Step ii)

2.2.2.1 Non-Percussive Crushing (Step i-1)

Non-percussive crushing following microwave treatment is performed using a manual hydraulic press (Specac Atlas 15T). The concrete samples are individually compressed. The stroke of the hydraulic press stops at 8 mm from the surface on which the RCAs are placed, corresponding to the maximum size of the NAs of the concrete samples.

2.2.2.2 Screening (Step ii-2)

The crushed sample is then screened by a dry process on standard 8-mm, 4-mm, 2-mm, 1-mm and 0.25-mm square mesh sieves in order to produce the 4/8-mm, 2/4-mm, 1/2-mm, 0.250/1-mm and 0/0.25-mm particle size fractions.

2.2.2.3 Abrasion (step a))

The 1/4-mm and 4/8-mm fractions of recycled concrete aggregates (RCA) produced by crushing then screening are abraded for a short time of 2 minutes separately in a cylindrical metal jar with an internal diameter of 10 cm, rotating at a speed of 100 rpm. The abrasive charge consists of 336 g of 20-mm alumina beads and 200 ml of water. The products are then re-screened at 8 mm and 4 mm to separate the 8-mm and 4-mm RCAs respectively from the abrasive fines.

At the end of steps ii-1), ii-2) and a), a plurality of fractions of fines are recovered and collected.

2.2.3 Carbonation of Fines (Step iii))

The fines obtained are ground to 80 μm using an automatic mortar and pestle, with an average size d₅₀=around 10 μm. This fineness is justified for the use of carbonated fines as a mineral additive. The step of carbonating the milled fines is carried out in suspension in a stirred reactor with a useful volume of 300 ml. The suspension used consists of a mixture of 15 g of recycled concrete fines and 150 ml of distilled water. The mixing is ensured by a mobile agitator rotating at 800 rpm. The carbonation reactor operates under a partial pressure of CO₂ of 5 bar with a controlled temperature of 60° C. A carbonation test lasts 20 hours, during which the consumption of CO₂ by the fines is continuously measured. The final carbonation rate of the carbonated fines is obtained by thermogravimetric analysis (TGA) or by total carbon measurement (CHNS analysis).

### Comparative Example 3: The Recycling of Concrete from Construction and/or Demolition Using a Method not According to the Invention

The method of the invention was compared to a non-percussive crushing method, which represents the most efficient current technology for the production of recycled concrete aggregates. This comparative method, referred to hereinafter as the “reference method”, was carried out using the same concrete samples as those described in point 2.1. The reference method consists of a mechanical treatment via non-percussive crushing and screening steps under the same conditions as those described in point 2.2.

A step of carbonating the fines is carried out as described in example 2, part 2.2.3.

### Example 4: Performance of the Method of the Invention

### 4.1 Performance Evaluation Criteria

The performance criteria used to characterize the performance of the method relate to the quality and use properties of the recycled concrete aggregates (RCA) and the recycled concrete fines.

### For the Recycled Concrete Aggregates (RCA):

### Quality:

Content (wt. %) of CP in a given RCA particle size fraction,
Content of clean RCAs (i.e. RCA having a CP content<5 wt. %) in a given RCA particle size fraction, and
Content (wt. %) of natural aggregates (NA) with the same particle size fraction as the RCAs.

### Use Properties:

Water absorption of the RCAs by the WA24 method. This test measures the water content of the RCAs after drying according to standard NF EN 1097-5. It is expressed as a weight percentage.
Wear resistance of the RCAs measured by the Micro Deval (MDE) test. This test measures the resistance to wear caused by friction between the RCAs and an abrasive load of steel balls, according to standard NF EN 1097-1. The test result is expressed as a % and represents the weight percentage of particles<1.6 mm produced during the test.

### For the Recycled Concrete Fines (<1 mm):

### Quality:

Content (wt. %) of mortar that the method concentrates in the fines (<1 mm) produced
Content (wt. %) of CP that the method concentrates in the fines (<1 mm) produced
Rate (wt. % of CO₂ captured) of carbonation of the fines.

### 4.2 Cleanliness of the Recycled Concrete Aggregates

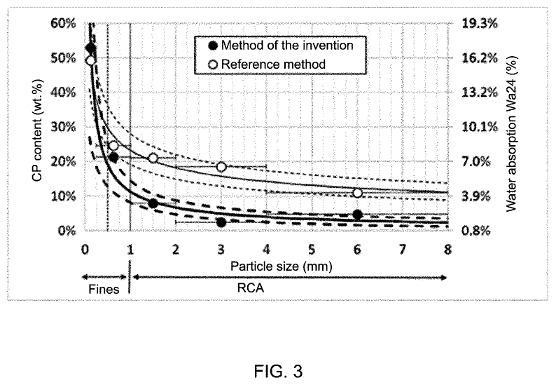

Appended FIG. 3 shows the measurement of cleanliness of the RCAs in terms of the variation in the content of residual CP (wt. %) (left) depending on the size of the RCAs for the method of the invention (solid circles) and for the reference method (empty circles). This content is measured by dissolving the RCAs with 4/8-mm, 2/4-mm, 1/2-mm, 0.250/1-mm and 0/0.25-mm particle size fractions in a solution of 19 wt. % hydrochloric acid.

The absence of overlap between the 95% confidence intervals for the mass fraction of residual CP down to an RCA particle size of 0.5 mm demonstrates that the method of the invention produces RCAs that are significantly cleaner than the RCAs produced by the reference method down to an RCA size of 0.5 mm.

Appended FIG. 3 also shows the measurement of the water absorption of the RCA (as a %) (right) depending on the size of the RCAs for the method of the invention (long dotted curves) and for the reference method (short dotted curves). This content is measured by dissolving the RCAs with 4/8-mm, 2/4-mm, 1/2-mm, 0.250/1-mm and 0/0.25-mm particle size fractions in a solution of 19 wt. % hydrochloric acid.

### 4.3 Product Speciation During the Method of the Invention

The fine analysis of product quality during the method of the invention (vs. the reference method) consists in measuring the speciation of the initial constituents of the concrete (NA and CP, see example 2, part 2.1) before and after the method of the invention (vs. the reference method) (example 2, part 2.2 and example 3). Speciation is used to refer to the traceability of the initial constituents in the products of the method of the invention (vs the reference method).

As a reminder, the products used to characterize the performance of the concrete recycling methods are 4/8 RCA, 2/4 RCA, 1/2 RCA and fines (particles<1 mm). The constituents of interest in the speciation measurement are the natural aggregates 4/8 NA, 2/4 NA, 1/2 NA, and the fines represented by 0.25/1 NA, 0/0.25 NA and the CP.

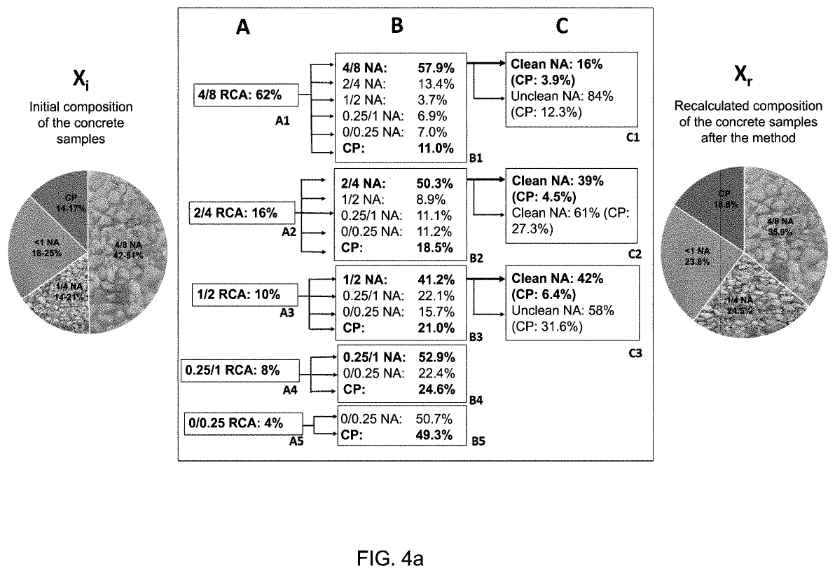

FIGS. 4a) and 4b) show this speciation in detail for the reference method and for the method of the invention, respectively. In these figures:
Xi and X′i depict the initial composition of the concrete samples, before carrying out the methods. This composition is the same for both the reference method and for the method of the invention.
Columns A and A′ show the mass distribution of the products (4/8 RCA, 2/4 RCA, 1/2 RCA and the fines) after carrying out the reference method and the method according to the invention, respectively. The products are separated by screening after crushing for the reference method (example 3), and after steps ii) and a) for the method of the invention (example 2, part 2.2); and their mass fractions are obtained by weighing.
Columns B and B′ show the speciation (in the form of mass percentage) of each of the products, in other words, of each of the fractions in columns A and A′: B1 (or B′1) corresponds to the speciation of 4/8 RCA of A1 (or A′1), B2 (or B′2) corresponds to the speciation of 2/4 RCA of A2 (or A′2), etc. Speciation measurement involves selective dissolution of the CP in each product in 23 wt. % hydrochloric acid, followed by screening (and optionally abrasion), weighing and drying of the particle size fractions of NA found after dissolution. Mass loss after dissolution gives a direct measurement of the mass of CP found in the products.
Columns C and C′ show the observed amount of clean NAs (or bare or clean RCAs) and NAs associated with an adherent residual mortar (or unclean or unclean RCAs), as well as the amount of CP in the selected fraction: C1 (or C′1) corresponds to the observations and measurements for the 4/8 NA fraction of B1 (or B′1), C2 (or C′2) for the 2/4 NA fraction of B2 (or B′2) and C3 (or C′3) for the 1/2 NA fraction of B3 (or B′3).
Xr and X′r represent the recalculated composition of the concrete samples, after carrying out the reference method and the method according to the invention, respectively. It is established on the basis of the values in columns B and B′, which give the speciation of the initial constituents of the concrete in the products.

As the fraction of the fines is defined as all particles smaller than 1 mm (0.25/1 RCA+0/0.25 RCA), the speciation analysis of the constituents shows that the method of the invention concentrates 31% of the mass of the concrete in this fines fraction (column A′ in FIG. 4b): 16% of A′4+15% of A′5), compared with only 12% for the reference method (column A in FIG. 4a): 8% A4+4% A5). The method of the invention therefore makes it possible to concentrate almost three times more fines than the reference method, fines which can be recycled as cement raw meal if they are not carbonated, or as mineral additives if they are.

The mass fraction of 4/8, 2/4 and 1/2 RCA in the method of the invention is very close to the mass fraction of the 4/8, 2/4 and 1/2 NA in the initial concrete, which can be explained by a mass fraction for recovery of NAs of more than 75%, or even 80%, in the RCAs. In other words, the RCAs produced by the method of the invention contain less than 20 wt. % of residual mortar, i.e. a CP mass fraction of 5 wt. % to 8 wt. % (see B′1, B′2 and B′3 in FIG. 4b).

By comparison, the RCAs of the reference method have an NA recovery rate of 40 wt. % to 60 wt. %, and therefore a mass fraction of residual mortar of 60 wt. % to 40 wt. % in the RCAs, i.e. a CP mass fraction of 11% to 21% (see B1, B2 and B3 in FIG. 4a).

The recalculation of the compositions Xr and X′r of the concrete samples indicates that the method of the invention preserves the size integrity of the initial NAs better than the reference method. In fact, the 4/8 NA content in the recalculated composition X′r of the reference method is significantly lower than that obtained for the method of the invention, which de facto leads to a greater increase in the 2/4 NA content with the reference method. This is due to the microfracturing of the CP induced by the microwave step, which avoids excessive NA fragmentation during the subsequent crushing step.

The degree of release (or degree of cleanliness) of the NAs in the RCAs was measured by visual sorting, with verification of the CP content of the separated fractions (columns C and C′). This measurement demonstrates the selectivity of the method of the invention with regard to NA recovery, this selectivity being provided by the microfracturing of the concrete induced by the microwave treatment step. This selectivity results in the heterogeneous distribution of the residual CP, which is concentrated in a small fraction of the NAs, while the majority of the RCAs have a particularly low CP content. These are referred to here as clean (or bare) NAs. The very high proportion of clean NAs in the RCAs is a specific feature of the method of the invention. The measurement of release by visual sorting was carried out on the 4/8-mm (B1 and B′1), 2/4-mm (B2 and B′2) and 1/2-mm (B3 and B′3) RCA fractions. On the right-hand side of FIG. 4b, illustrated by column C′, it can be seen that over 60-70% of the RCAs produced by the method of the invention are clean (i.e. RCAs containing 1.6% to 3.2% of CP), with the remaining 30-40% concentrating the CP with a CP content of 3.9% to 10.7%. Illustrated by column C in FIG. 4a), the degree of release (or degree of cleanliness) of the RCAs of the reference method only ranges from 16% to 42%. In summary, for the three RCA particle size classes analyzed, the degree of release (or degree of cleanliness) of the NAs is two times higher for the method of the invention than for the reference method.

The performance of the method of the invention was compared with that of the reference method and the theoretical limit. By way of example, the theoretical limit of cleanliness for an RCA in terms of residual CP content is 0%, while the maximum % of 4/8-mm NAs in the 4/8-mm RCAs is 100%. All percentages are given as wt. %.

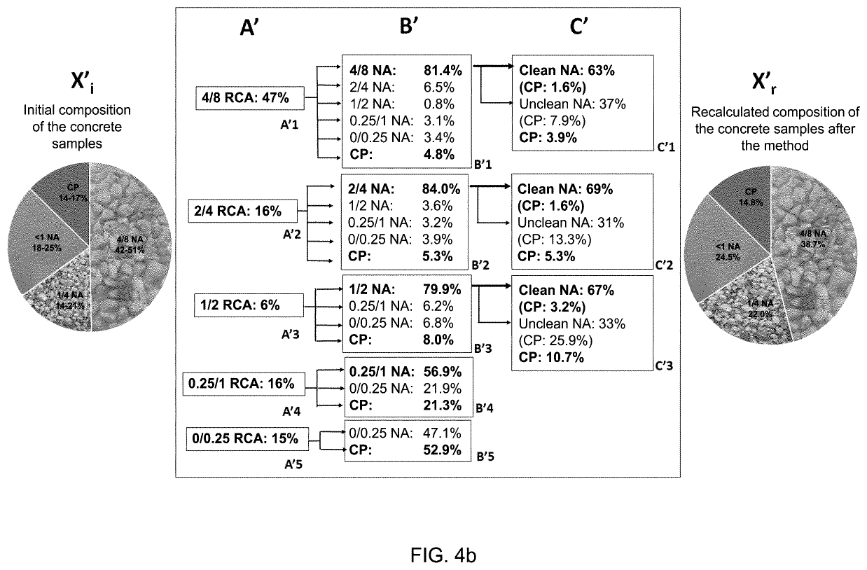

FIG. 5 shows the performance of the method of the invention with respect to the reference method, and with respect to the theoretical limit.

### 4.4 Characterization of Carbonation

At best, the aqueous carbonation methods can achieve about 80% of the theoretical carbonation limit of solids, calculated on the basis of their chemical composition.

The theoretical carbonation limit of the fines is directly related to the amount of calcium (Ca) they contain. Per mass unit of fines, this theoretical limit is similar for the fines of the method of the invention and of the reference method, since the measurements show that they have the same chemical composition. This theoretical limit is between 170 kg and 200 kg of CO₂/metric ton of fines. Conversely, the method of the invention makes it possible to produce 2.6 times more fines than the reference method, so that the method of the invention can at most store 2.6 times more CO₂ per metric ton of recycled concrete than the reference method. This represents a CO₂ storage potential for the method of the invention of 60 kg of CO₂/metric ton of recycled concrete, compared with 20 kg of CO₂/metric ton of recycled concrete for the reference method, bearing in mind that the maximum potential for concrete carbonation is estimated on the same basis at 70 kg of CO₂/metric ton of recycled concrete. Thus, in the fines, with respect to one metric ton of recycled concrete, the method of the invention makes it possible to store up to three times more CO₂ than the reference method (table 4 hereunder).

TABLE 4

| | Fines of the | Fines of the |
|---|---|---|
| | reference | method of the |
| | method | invention |
| % CP | 33% | 37% |
| % NA | 67% | 63% |
| Theoretical limit of carbonation | 170 | 200 |
| (kg of CO₂/metric ton of fines) | | |
| Theoretical limit of carbonation | 20 | 60 |
| for fines, with respect to one | | |
| metric ton of concrete (kg of | | |
| CO₂/metric ton of concrete) | | |

The final carbonation rate of the carbonated fines is obtained by measuring the total carbon (CHNS analysis).

Table 5 hereunder lists the results for the fines obtained according to the reference method and according to the method of the invention.

TABLE 5

| | % C | kg of | |
|---|---|---|---|
| | (CHNS | CO₂/metric | Carbonation |
| | measurement) | ton of fines | rate |
| Reference method | 2.69 | 116 | 68% |
| Method of the | 3.10 | 150 | 78% |
| invention | | | |

The experimental measurement confirms that the carbonation potential of the fines is similar for the method of the invention and the reference method, which results from their similar chemical compositions. However, the results are substantially favorable for the fines produced by the method of the invention, with a carbonation increase of +1.3 with respect to the fines produced by the reference method. This result, plus the observation during carbonation testing of fines that the fines of the method according to the invention carbonate with better kinetics than those of the reference method, is probably the result of the microfracturing of the CP induced by the microwave treatment step, which facilitates the transfer of carbon dioxide (CO₂) to the elements that can be carbonated (calcium) found in the CP.

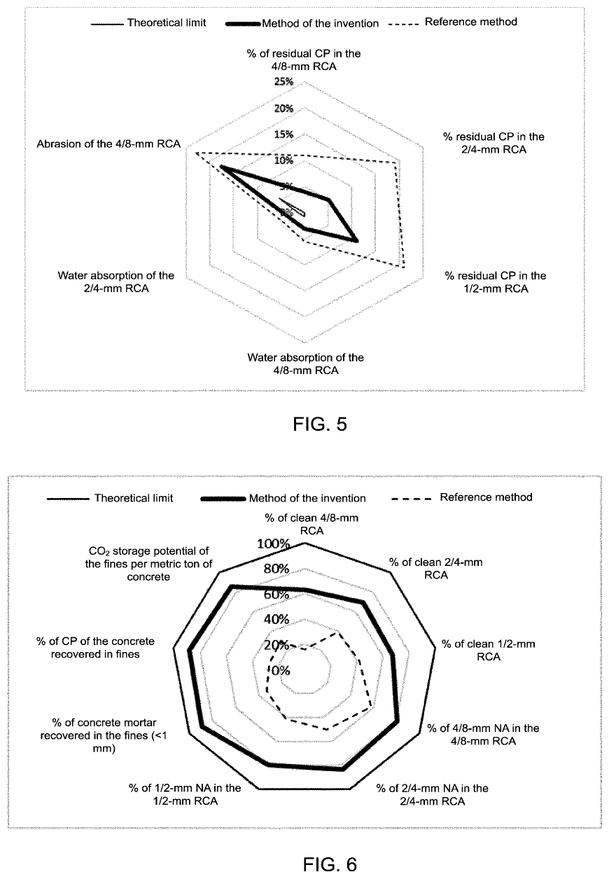

FIG. 6 shows the performance of the method of the invention with respect to the reference method, and with respect to the theoretical limit.

Across all the performance criteria measured, the method of the invention is on average 2.3 times more efficient than the reference method.

1-15. (canceled)

16. A method for recycling concrete from construction and/or demolition, comprising at least the following steps:
i) one or more steps of microwave treatment of concrete blocks from construction and/or demolition with a size on the centimeter scale, to form microfractured concrete blocks,
ii) one or more steps of mechanical treatment making it possible to extract, from said microfractured concrete blocks, recycled aggregates comprising bare natural aggregates and natural aggregates associated with an adherent residual cementitious matrix; and recycled fines,
iii) one or more steps of carbonating the recycled aggregates, in the presence of carbon dioxide, to form carbonated recycled aggregates, and/or
iv) one or more steps of carbonating the recycled fines, in the presence of carbon dioxide, to form carbonated recycled fines.

17. The method according to claim 16, wherein the concrete blocks from construction and/or demolition have a size of at most 10 cm.

18. The method according to claim 16, wherein the microwave treatment of step i) is carried out for a time ranging from 30 s to 10 min.

19. The method according to claim 16, wherein the microwave treatment i) is carried out at a frequency ranging from 915 MHz to 2450 MHz.

20. The method according to claim 16, wherein the bare natural aggregates are selected from gravel, sands with a particle size of 1 mm or more, and one of the mixtures thereof; and the natural aggregates associated with an adherent residual cementitious matrix are selected from gravel, sands with a particle size of 1 mm or more, and one of the mixtures thereof.

21. The method according to claim 16, wherein the adherent residual cementitious matrix associated with the natural aggregates comprises natural aggregates having a particle size of less than 1 mm.

22. The method according to claim 16, wherein step ii) comprises at least one step ii-1) of milling the microfractured concrete blocks.

23. The method according to claim 22, wherein step ii) further comprises at least one screening step ii-2).

24. The method according to claim 16, wherein the recycled aggregates have a maximum particle size G_{M} of at most 45 mm, or at most 25 mm, or at most 11.2 mm, or at most 8 mm, or at most 4 mm.

25. The method according to claim 16, wherein the recycled aggregates have a particle size Gₘ of at least 1 mm.

26. The method according to claim 16, further comprising at least one step a) of cleaning the recycled aggregates.

27. The method according to claim 26, further comprising at least one step b) of washing the recycled aggregates.

28. The method according to claim 16, wherein step iii) is carried out in the presence of a gas comprising at least 10 mol. % of CO₂, with respect to the total number of moles of gas.

29. A recycling installation for carrying out a recycling method as defined in claim 16, comprising:
at least one microwave tunnel for forming microfractured concrete blocks from concrete blocks from construction and/or demolition with a size on the centimeter scale,
at least one roller mill for fragmenting the microfractured concrete blocks and releasing recycled aggregates comprising bare natural aggregates and natural aggregates associated with a cementitious matrix; and recycled fines,
at least one vibrating, gyratory or rotary screen or sieve for separating the recycled aggregates from the recycled fines, optionally cleaning them, and optionally washing them, and
at least one carbonation reactor for forming carbonated recycled aggregates and/or carbonated recycled fines.

30. A recycled aggregates (RCA) obtained according to a method as defined in claim 16, wherein the RCAs with a given particle size fraction, of 1 mm or more, comprise at least 50 wt. % of bare natural aggregates with said given particle size fraction, with respect to the total weight of the RCAs with said given particle size fraction.
